(19) United States
(12) Patent Application Publication
(10) Pub. No.: US 2010/0283785 A1
(43) Pub. Date: Nov. 11, 2010

(54) Detecting peaks in two-dimensional signals

(75) Inventor: Javier E. Satulovsky, Santa Clara, CA (US)

Correspondence Address: Agilent Technologies, Inc. in care of:;CPA Global, P. O. Box 52050, Minneapolis, MN, 55402, US

(73) Assignee: AGILENT TECHNOLOGIES, INC., Loveland, CO (US)

(21) Appl. No.: 12/463,566

(22) Filed: May 11, 2009

(51) Int. Cl. G06T 11/20; G06K 9/46

(52) U.S. Cl. 345/440; 382/207

(57) ABSTRACT

A system for detecting true peaks in a two-dimensional signal includes a two-dimensional separator and a processor. The two-dimensional separator is configured to perform separation of a sample to provide the two-dimensional signal. The processor is configured to identify candidate peaks of the two-dimensional signal based on local maxima of points on a surface defined by the two-dimensional signal, and to identify at least one true peak from the candidate peaks.

### BACKGROUND

Two-dimensional chromatography is a tool for analyzing complex samples, or for reducing sample complexity prior to analysis in mass spectrometry, for example. After baseline and/or noise removal, peak detection is a prerequisite to subsequent chemometric quantitation steps in one- or two-dimensional chromatography. While there are established methods for peak detection of chromatograms in one dimension, conventional methods for two-dimensional chromatography typically miss identification of highly overlapped peaks or are very complex, requiring a user to supervise the procedure and to interactively optimize several parameters.

For example, one conventional approach for detecting peaks in two-dimensional chromatograms includes a “watershed segmentation” algorithm. Generally, in the watershed segmentation algorithm approach, the two-dimensional signal of interest is effectively treated as a digital image and the measured signal intensity in two dimensions becomes the “pixel” value of the image. However, the watershed segmentation algorithm is not able to deal with highly overlapped peaks. For example, as shown in FIGS. 1(A) and 1(B), when there is a well defined shoulder between two peaks (indicated by dots), as shown in FIG. 1(A), the watershed segmentation algorithm is able to distinguish the peaks. However, when there is significant overlap of peaks, as shown in FIG. 1(B), i.e., where no shoulder can be readily identified, the flooding watershed segmentation algorithm fails, detecting only the highest of the overlapping peaks.

Another conventional algorithm includes an extension of peak detection algorithms used in one-dimensional chromatography. In the one-dimensional approach, information from derivatives of the signal is used. For example, in a one-dimensional chromatogram, a peak can be detected as a point where the second derivative (the curvature of the signal of interest) has a local minimum. This is schematically illustrated in FIG. 2, for example, where positions of peaks in a highly overlapped peak cluster may be detected by searching for minima in the second derivative (f″(t)).

This procedure has been extended to two-dimensional chromatography. For example, one-dimensional peak detections are performed along each of the one-dimensional data sets of points in the second dimension. Then, a peak merging procedure collapses the redundant peaks identified previously in order to eliminate redundancy and to identify peaks in two dimensions. However, the merging procedure uses a decision tree with four parameters that are specified by the user. Since the initial values of these parameters are not known a priori, the user must manually optimize the four variables, which is difficult, time consuming and unreliable.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1(A) and 1(B) are graphs showing signal peaks in one-dimensional chromatograms according to a conventional method.

FIG. 2 shows graphs of signal peaks and derivatives of the signal peaks in one-dimensional chromatograms according to a conventional method.

FIG. 3 is a functional block diagram illustrating a system for detecting signal peaks, according to a representative embodiment.

FIG. 4 is a flow diagram of a method for signal peaks, according to a representative embodiment.

FIG. 5 is a flow diagram of a method for noise reduction in FIG. 4, according to a representative embodiment.

FIG. 6 is a graph showing a power spectrum, according to a representative embodiment.

FIG. 7 is a flow diagram of a method for identifying candidate peaks in FIG. 4, according to a representative embodiment.

FIG. 8 is a graph of a three-dimensional data set showing normal vectors for detecting signal peaks, according to a representative embodiment.

FIG. 9 is a flow diagram of a method for performing peak identification, according to a representative embodiment.

FIG. 10 is a graph of a three-dimensional data set showing selected peaks, according to a representative embodiment.

FIGS. 11(A) and 11(B) are graphs of three-dimensional data sets showing selected peaks, according to representative embodiments.

FIG. 12 is a functional block diagram illustrating a system for detecting signal peaks, according to a representative embodiment.

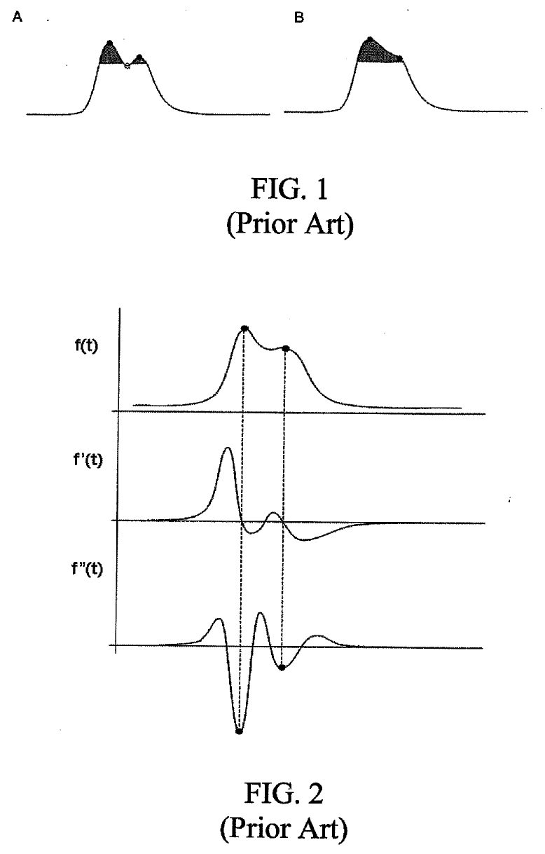

### DETAILED DESCRIPTION

In the following detailed description, for purposes of explanation and not limitation, illustrative embodiments disclosing specific details are set forth in order to provide a thorough understanding of an embodiment according to the present teachings. However, it will be apparent that other embodiments according to the present teachings that depart from the specific details disclosed herein remain within the scope of the appended claims. Moreover, descriptions of well-known devices and methods may be omitted so as to not obscure the description of the embodiments. Such methods and devices are clearly within the scope of the present teachings.

In the various embodiments, positions of actual or true peaks are identified in two-dimensional separations, such as peaks generated by gas and/or liquid chromatography, for example, using an extension of differential geometry concepts applied to one-dimensional signal processing. The peaks are identified based on a parameter indicating an acceptable noise-to-signal ratio for the peaks. Although the parameter may be specified by a user in an embodiment, the process generally requires minimal user intervention. The position of the peaks detected can then be used as input for deconvolution routines to further determine the precise location and volume of each peak.

While pertinent to gas and liquid chromatography, it is to be understood that various embodiments may be applicable to signals arising from any two-dimensional separation, such as separations from two-dimensional gel electrophoresis and mass spectrometry, which may be performed by a microfluidic device, for example. Liquid chromatography/mass spectrometry (LC/MS), in particular, generally combines separation functionality of liquid chromatography with mass analysis ability of mass spectrometry. LC/MS measurements provide two-dimensional signals, having corresponding three-dimensional data sets that may be graphed along an x-axis indicating spectrum number or intensity, a y-axis indicating elution time, and a z-axis indicating mass-to-charge m/z ratio values, for example. LC/MS may be used to detect and identify molecules, chemicals, proteins and the like, in a complex mixture.

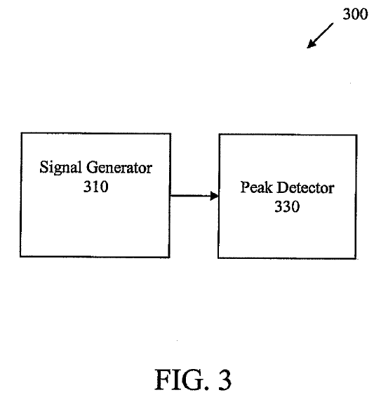

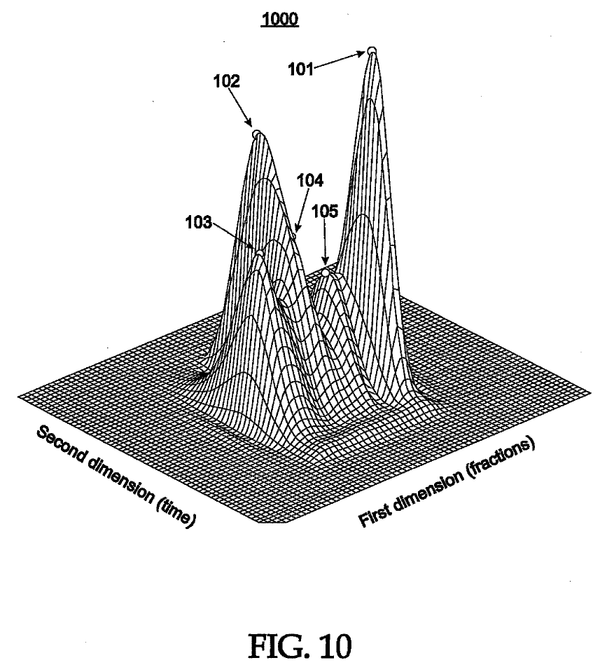

FIG. 3 is a functional block diagram illustrating a system 300, according to a representative embodiment. The system 300 may be an LC/MS system, for example, which collects, measures, processes and/or analyzes various samples for identification and generates two-dimensional representations based on three-dimensional data sets. [0022] In the depicted representative embodiment, the system 300 includes a signal generator 310 and a peak detector 330. The signal generator 310 is configured to generate a two-dimension signal that exhibits peaks, as shown for example in FIG. 10, discussed below. The signal generator 310 may be embodied as a two-dimensional sample separator, for example, which receives samples, which may include various mixtures of molecules (e.g., peptides, proteins, or the like) to be identified. As stated above, the samples may be separated by the two-dimensional separator via various types of separation processing to reduce the complexity of the mixture and to isolate to the extent possible individual compounds contained within sample. A two-dimensional separator may perform separation processing in accordance with any appropriate separation system, including two-dimensional gel electrophoresis and LC/MS, and may be implemented in part using a microfluidic device, for example.

The peak detector 330 performs processing operations on the received signals, e.g., from sample separations, including the peak detection process, in accordance with various embodiments discussed below. In various embodiments, the peak detector 330 performs processing operations, and may be implemented as a microprocessor, a digital signal processor (DSP), or the like, or may be implemented at least in part by hard-wired logic circuits or customizable hardware. As stated above, although depicted separately, the peak detector 330 may be included within the signal generator 310, in various embodiments.

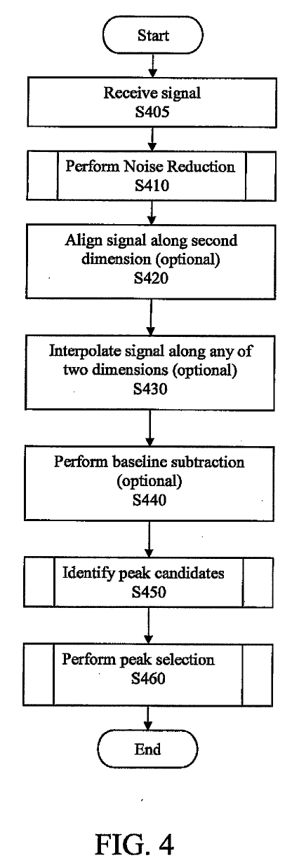

FIG. 4 is a flow diagram illustrating a method for detecting signal peaks, according to a representative embodiment. The various operations of the method may correspond to modules, realized by hard-wired logic circuits or customizable hardware, a program running on a processor, such as the peak detector 330, or any combination thereof.

Referring to block 405 FIG. 4, a two-dimensional signal S(x, y) is received, e.g., at the peak detector 330 from the signal generator 310, where x and y represent variables in two dimensions. The signal S(x, y) is de-noised at block 410 to obtain a smooth signal Sₛₘₒₒₜₕ(x, y). The smooth signal Sₛₘₒₒₜₕ(x, y) may be optionally aligned along a second dimension at block 420 and optionally interpolated along one of the two dimensions at block 430, either manually by the user or automatically, to improve signal quality. Also, a baseline of the smooth signal Sₛₘₒₒₜₕ(x, y) may be optionally subtracted at block 440. “Candidate peaks” are identified on a two-dimensional surface defined by the smooth signal Sₛₘₒₒₜₕ(x, y) by the process indicated by block 450. Candidate peaks generally are local maxima on the two-dimensional surface defined by the smooth signal Sₛₘₒₒₜₕ(x, y). “True peaks” are identified and selected from among the candidate peaks according to the process indicated by block 460, indicating the actual peaks on the two-dimensional surface defined by the smooth signal Sₛₘₒₒₜₕ(x, y). The definition of what constitutes a true peak may a user-defined parameter, referred to as “stringency,” indicating how large a signal-to-noise ratio of a candidate peak may be in order to be considered a true peak. Each operation of FIG. 4 is discussed in more detail, below.

At block 405, the two-dimensional signal S(x, y) is received, where x and y represent variables in two dimensions. For example, in a representative embodiment, x represents a discrete variable associated with a first dimension, such as a fraction resulting from strong anion exchange chromatography, and y represents a discrete variable corresponding to a second dimension, such as time along a reversed-phase separation. The signal S(x, y) may be based on samples separated by the signal generator 310 of FIG. 3, for example, although it is understood that the method depicted in FIG. 4 may include receiving and processing various types of two-dimensional signal S(x, y), including signals generated with continuous spatial and/or temporal distributions. For example, an alternative embodiment may include a two-dimensional signal resulting from superposition of light from different sources, located close together.

At block 410, a process is performed for reducing noise in the signal S(x, y). Since derivatives of a noisy signal generally amplify noise with each successive derivation, it is usually necessary to de-noise the signal S(x, y). In order to reduce noise, filtering may be performed on higher frequencies of the signal S(x, y). Various methods of noise reduction include, for example, Fourier domain filtering and Savitzky-Golay filtering. In an embodiment, the high frequency filtering may include a Fast Fourier Transform (FFT) since implementation of the FFT operation can also be used should signal interpolation (e.g., block 430) be necessary.

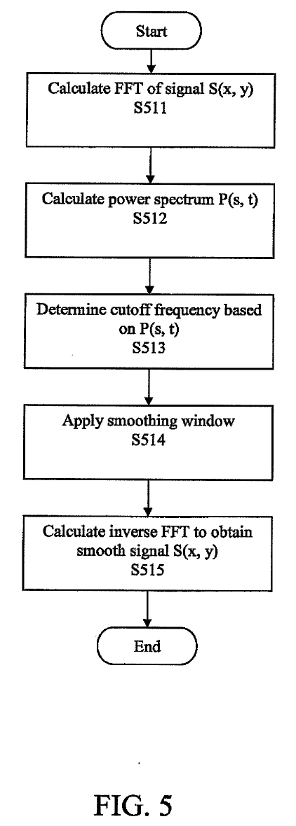

FIG. 5 is a flow diagram illustrating a representative method for performing the noise reduction process indicated by block 410 of FIG. 4, according to a representative embodiment. At block 511, a FFT F(s, t) of signal S(x, y) is calculated, where s and t are spatial frequencies in the x and y direction. At block 512, the power spectrum P(s, t) of signal S(x, y) is calculated using F(s, t).

At block 513, a cutoff frequencies indicated by s* and t* are determined based on the power spectrum P(s, t) as a direct generalization of a procedure performed in one-dimensional power spectra via a variance calculation. An example of a procedure to determine a cutoff frequency for the case of a one dimensional power spectrum P(s) is disclosed by Felinger, Data Handling in Science and Technology, ELSEVIER (1998), pp. 183-190, the contents of which are hereby incorporated by reference. For example, starting from one end of the spectrum (e.g., highest frequencies), the variance of the power spectrum P(s, t) may be calculated along a small window. The window size is small compared to the number of data points in the spectrum, but large enough to provide a value that is independent of small variations in the size of the window. As the size of the window increases, the variance of the window eventually transitions from a constant value to a regime in which the variance starts to rapidly increase. This can be accomplished algorithmically, for example, by comparing the variance of a window of size l, varₗ, with the variance of a window of size l+1, varₗ₋₁, and identifying the frequency, s*, for which varₗ₊₁>2 varₗ takes place for the first time, where s* is the starting frequency of the window of size l+1. The cutoff frequency is generalized into two dimensions, the process for which would be apparent and therefore is not specifically described herein. When the domain of the signal or portion of the two-dimensional signal being analyzed is a square, the two cutoff frequencies coincide (s*=t*), and when it is a rectangle, the two cutoff frequencies differ.

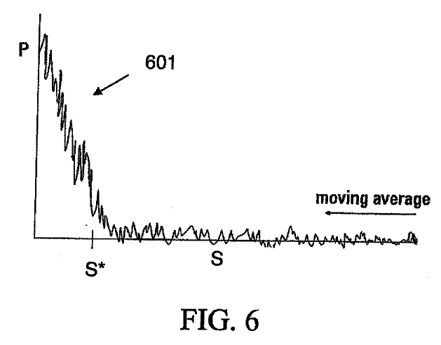

An example of determining a cutoff frequency s* is schematically illustrated in FIG. 6, which shows a power spectrum of a one-dimensional signal, as opposed to a two-dimensional signal, for purposes of explanation. Of course, the graph of FIG. 6 may be extended to a two-dimensional signal. Curve 601 shows a representative power spectrum in which power P(s) is plotted along the spatial frequency s, with a moving average walking from higher to lower frequencies. The cutoff frequency s* is the point at which the curve 601 transitions from its initial relatively constant value to rapidly increasingly values, indicating a transition from frequencies associated with noise to frequencies associated with the actual signal.

Using the cutoff frequencies indicated by s* and t*, a smoothing window, such as a Hamming window, is applied to filter the FFT, F(s, t) at block 514. Application of a Hamming window is described, for the case of a one-dimensional signal, by Felinger, Data Handling in Science and Technology, ELSEVIER (1998), pp. 183-190. The purpose of the Hamming window is to dampen the frequency spectrum such that it becomes zero after the cutoff frequency s*. When using a Hamming window, the Fourier transform of a one dimensional curve is V(s)=0.5+0.5 cos (πs/s*), if s<s*. Otherwise, V(s)=0. Again, generalizing the cutoff frequency s* and the Hamming window to two dimensions would be apparent, and therefore is not specifically described herein. It is understood that types of windows other than a Hamming window may be incorporated at block 514 without departing from the scope of the disclosure.

An inverse FFT is calculated at block 515 to obtain a smooth signal, Sₛₘₒₒₜₕ(x, y). It is understood that other methods may be used to reduce the noise in the signal S(x, y) without departing from the scope of the present disclosure.

Once the smooth signal Sₛₘₒₒₜₕ(x, y) is obtained at block 515, the process returns to FIG. 4. The smooth signal Sₛₘₒₒₜₕ(x, y) may be optionally aligned along a second dimension at block 420. It is generally assumed that chromatographic runs along the second dimension are reproducible to the extent that the surface of the smooth signal Sₛₘₒₒₜₕ(x, y) is differentiable. In this case, alignment along the second dimension is unnecessary. When the retention time of compounds along the second dimension shows variability, the chromatographic runs must be first aligned using any method for alignment of chromatograms, which would be apparent. For example, Correlation Optimized Warping (COW) may be used, as described by Sadygov et al., ChromAlign: A Two-Step Algorithmic Procedure for Time Alignment of Three-Dimensional LC-MS Chromatographic Surfaces, ANAL. CHEM., Vol. 78, No. 24 (Nov. 17, 2006), pp. 8207-8217, the contents of which is hereby incorporated by reference. The essence of the COW method is to align two curves (e.g., runs along the second dimension) by maximizing Pearson correlation coefficients between them. In order to simultaneously align all the curves comprising the second dimension of a two dimensional dataset, an optimization is performed on the sum of all pair-wise correlations.

Also, the smooth signal Sₛₘₒₒₜₕ(x, y), either with or without alignment along the second dimension, may be optionally interpolated along one of the two dimensions at block 430 of FIG. 4, either manually by the user or automatically. Generally, due to experimental methods used for data acquisition and other setup details, such as steepness of gradients and the amount and number of fractions, one of the two dimensions in the separation may have less resolution than the other (e.g., fewer points and more signal variation between consecutive points). Alternatively, both dimensions may have poor resolution. Since the representative peak detection process uses topological properties associated with slope of the surface of Sₛₘₒₒₜₕ(x, y), the resolution in both dimensions should be similar for accurate determination of the peak positions.

In order to automatically detect uneven resolution along the two dimensions for any given peak, for example, when the cross section of the peak along one dimension shows a much lower number of points than a cross section of the peak along the other dimension, the following procedure may be used, in a representative embodiment. Standard deviations of the differences in consecutive values of the signal along the first dimension are calculated. The procedure is repeated for values of the signal along the second dimension. Then, the largest standard deviation is divided by the smallest standard deviation. Typically, a ratio below two indicates that both dimensions are resolved to an equivalent degree, while a ratio above two is indicative of uneven resolution.

When used, interpolation is performed in both dimensions simultaneously. When one dimension has higher resolution than the other, the data set corresponding to the dimension having the higher resolution is decimated, accordingly. For example, if y is the dimension having the higher resolution (where y=0, 1, 2, . . . m), a new signal S*ₛₘₒₒₜₕ(x, y*) is created, such that y*=0, 2, 4, . . . m. The decimation can be carried out as many times as necessary until the two dimensions have similar resolutions. When both dimensions have poor resolution, decimation is not required.

However, when at least one of the dimensions has poor resolution, interpolation is performed using a standard procedure of zero filling, as described, for example, by Sundarajan, The Discrete Fourier Transform, WORLD SCIENTIFIC (2001), pp. 86-89. For clarity, a general description for a one-dimensional signal is provided. The procedure may be extended to a two-dimensional signal, as would be apparent. Given a function and its Fourier transform, the maximum frequency, ωₘₐₓ, of the Fourier transform may be determined. The Fourier transformed signal is extended by adding zeroes after ωₘₐₓ. When (k−1)*N zeroes are added after ωₘₐₓ to continue the N-point Fourier spectrum, where k and N are real numbers, the maximum frequency becomes:

ω_{2,max}=kωₘₐₓ

When the new Fourier spectrum is inversely transformed, the number of data points has increased k-fold with respect to the original signal. In the two-dimensional case, any uneven number of points (usually 1 or 3) can be intercalated in the original signal, thereby improving overall resolution. Any combination of these and other interpolation techniques may be used to obtain a usable two-dimensional smooth signal Sₛₘₒₒₜₕ(x, y) having equal resolutions in both dimensions.

At block 440, baseline subtraction or removal may also be optionally performed on the smooth signal Sₛₘₒₒₜₕ(x, y). Baseline subtraction may include methods that use regression to specific functions to the baseline (e.g. polynomials of different degrees and splines) and methods that analyze the signal in frequency space, like Fourier, or Wavelet transforms, as would be apparent.

Although shown following block 430 (signal interpolation) in FIG. 4, the baseline subtraction of block 440 does not necessarily have to be performed at this point in the process. For example, the baseline subtraction of block 440 may be performed prior to signal interpolation, immediately following noise reduction performed at block 410 and/or immediately following signal alignment performed at block 420.

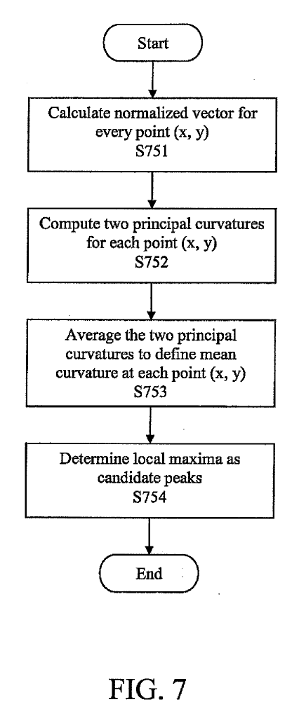

In the process indicated at block 450 of FIG. 4, candidate peaks are identified on the two-dimensional surface defined by the smooth signal Sₛₘₒₒₜₕ(x, y), which may have been aligned and/or interpolated at blocks 420 and 430, as discussed above. More particularly, FIG. 7 is a flow diagram illustrating a representative method for performing candidate peak identification indicated by block 450 of FIG. 4, according to a representative embodiment.

According to the embodiment depicted in FIG. 7, a normalized vector is calculated at block 751 for every point (x, y) on the surface defined by the smooth signal Sₛₘₒₒₜₕ(x, y) (for which there is a value of x and y), where each normalized vector is perpendicular to the surface at the corresponding point (x, y). The normalized vectors may be calculated according to various techniques, as would be apparent.

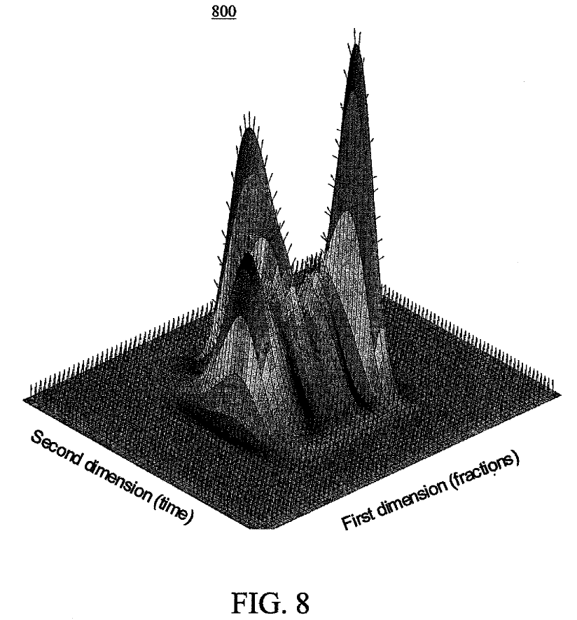

FIG. 8 is a graph 800 of a three-dimensional data set of a de-noised, two-dimensional smooth signal Sₛₘₒₒₜₕ(x, y), showing a subset of an actual two-dimensional gas chromatography run from a kerosene sample, for example. The vertex normals of the gas chromatography as determined at block 751 have been calculated and are indicated by arrows normal to the surface of smooth signal Sₛₘₒₒₜₕ(x, y) at every point (x, y). The smooth signal Sₛₘₒₒₜₕ(x, y) is plotted along first dimension (e.g., fractions) and second dimension (e.g., time). An example of calculating normalized vectors for every point (x, y) are disclosed by Batagelo, et al., Estimating Curvatures and their Derivatives on Meshes of Arbitrary Topology from Sampling Directions, THE VISUAL COMPUTER, Vol. 23, Nos. 9-11 (2007), pp. 803-812 (hereinafter Batagelo et al.), the contents of which is hereby incorporated by reference. To calculate the normal to the surface at a point (x, y), a set of vectors originating from (x, y) is first calculated by finite differences, which vectors are also tangent to the surface Sₛₘₒₒₜₕ(x, y) at point (x, y). The projection of these vectors in the X,Y plane should also be evenly distributed around (x, y), in that they cover the angular space evenly around (x, y). Since most relevant signals are defined on a regular lattice, this condition is automatically satisfied. Next, the normalized vector product of each contiguous pair of tangent vectors (rᵤ, rᵥ) is calculated:

$$n = \frac{{r}_{u} \times {r}_{v}}{‖ {r}_{u} \times {r}_{v} ‖}$$

By adding all the normalized vector products from each contiguous pair of tangent vectors (corresponding to each facet of the surface), and normalizing the final vector, the estimate of the unit normal vector at point (x, y) is obtained. A variant of this approach, described by Thürmer et al., Computing Vertex Normals from Polygonal Facet, JOURNAL OF GRAPHIC TOOLS 1(3) (1988), pp. 43-46, the contents of which is hereby incorporated by reference, uses the angle between each contiguous pair of tangent vectors as weight in the summation previously mentioned.

At block 752, two principal curvatures are computed at each point (x, y) of the surface of smooth signal Sₛₘₒₒₜₕ(x, y) using the corresponding normalized vector. The two principal curvatures are averaged at block 753 to define the mean curvature of the surface at each point (x, y). In an embodiment, one or more rounds of convolution of the mean curvature of the surface at each point (x, y) may be performed using a Gaussian filter, for example, in order to reduce noise in the curvature field. The two principal curvatures and the mean curvature at each point may be determined according to any appropriate technique, including the technique described by Batagelo et al. in the context of image processing, for example. That is, the intensity value of each pixel in the image processing application corresponds to the intensity value of the chromatography signal in the two-dimensional separation. In order to arrive at the mean curvature, a 2×2 matrix W forming the Weingarten equation must be diagonalized:

$$[ \frac{{n}_{u}}{{n}_{v}} ] = W * [ \frac{{r}_{u}}{{r}_{v}} ]$$

For example, referring to blocks 751 through 753, the Weingarten equation, above, shows how to obtain the normal to the surface at each point (nᵤ, nᵥ) by multiplying W by the normal basis vector (rᵤ, rᵥ). Once W is diagonalized, principal curvatures of the surface at that point are found as the eigenvalues of W, kₘₐₓ and kₘᵢₙ, for example, where kₘₐₓ and kₘᵢₙ are the principal curvatures. The mean curvature of the surface at that point, H, is defined as the average of the two principal curvatures, as follows:

$$H = \frac{{K}_{min} + {K}_{max}}{2}$$

Any other method of numerically estimating mean curvature may be used, as long as the estimation does not depart significantly from the actual value of the mean curvature. For example, the mean curvature may be estimated without calculating vectors normal to the surface and/or calculating principal radii of curvature.

At block 754, local maxima of H are determined on the surface Sₛₘₒₒₜₕ(x, y) to generate candidate peaks on the surface. The local maxima may be determined, for example, by identifying a local neighborhood of each point (x, y) on the surface Sₛₘₒₒₜₕ(x, y), and determining whether the value of mean curvature H at point (x, y) is greater than the value of mean curvature H in the other points included in the local neighborhood of the point (x, y). When the value of mean curvature H at the point (x, y) is higher than the values of mean curvature H at the other points, then point (x, y) is identified as a local maximum, and thus a candidate peak. As a result, multiple candidate peaks are detected on the surface Sₛₘₒₒₜₕ(x, y), relative to neighboring points, providing flexibility and internal consistency in defining the candidate peaks.

The detected candidate peaks include true peaks (e.g., peaks 101-105 of FIG. 10, discussed below), as well as ancillary peaks. Examples of ancillary peaks may include local maxima corresponding to noise (e.g., not eliminated by the smoothing procedure) and/or small waves at the end of the signal support that are introduced as artifacts of the FFT operations performed during de-noising (block 410 of FIG. 4). Even though they are artifacts, such ancillary peaks may be useful, for example, to define the background value or baseline of the signal.

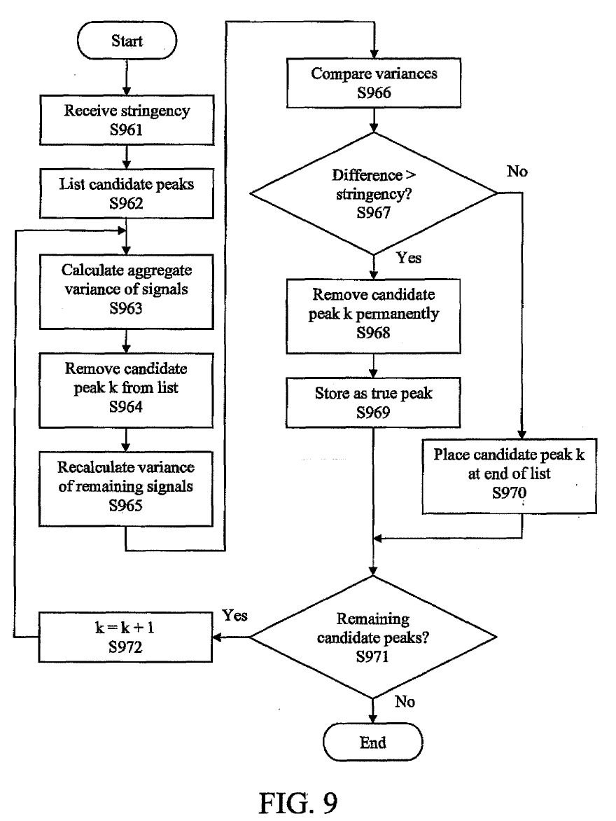

Returning to FIG. 4, at block 460, a peak selection process is performed to identify the true peaks among the candidate peaks detected in accordance with the process indicated by block 450. FIG. 9 is a flow diagram illustrating a representative method for performing the peak selection process indicated at block 460 of FIG. 4, according to a representative embodiment. For purposes of explanation, the process of FIG. 9 assumes that the background signal or baseline does not change substantially along the region of the signal being analyzed.

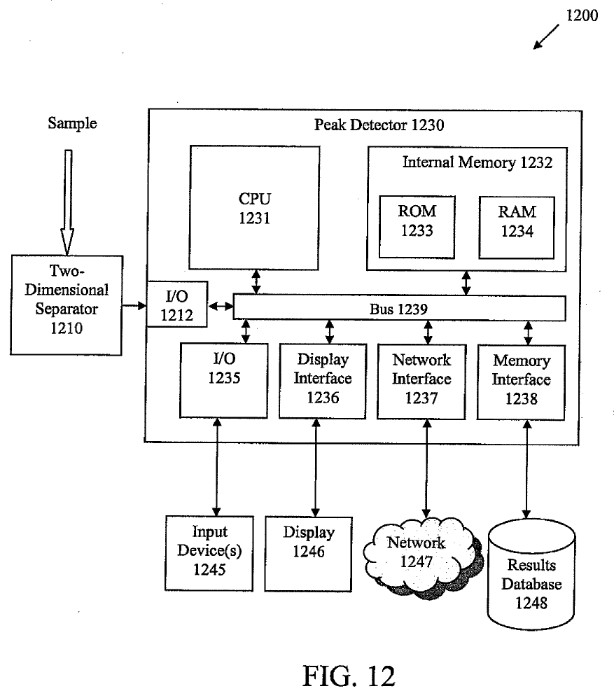

Initially, a parameter is received at block 961, referred to as “stringency,” indicating a threshold for determination of the true peaks. In an example, the parameter is defined by a user, and may be received through an input device (e.g., input device 1245 and corresponding I/O 1235 of the representative system 300 shown of FIG. 12, below). The user-defined stringency indicates how large the signal-to-noise ratio of a candidate peak must be in order for the candidate peak to be considered a true peak. In alternative embodiments, a stringency value may be determined automatically (e.g., without user involvement), for example, based on the range of signal-to-noise ratios of the candidate peaks identified at block 450 of FIG. 4.

Once the stringency value has been specified, selection of the true peaks is accomplished through iterative elimination. First, a list of all candidate peaks and their signals is built at block 962. In an example, the candidate peaks are in no particular order. The candidate peaks are indicated by the (x, y) coordinates of the corresponding surface points of the two-dimensional smooth signal Sₛₘₒₒₜₕ(x, y). A variance of values of the smooth signal Sₛₘₒₒₜₕ(x, y) at locations corresponding to all the candidate peaks in the list is calculated at block 963. The variance of the signals corresponding to all the candidate peaks will be referred to as an “aggregate variance.”

A candidate peak, indicated by index k (where k is a positive integer), is removed from the list at block 964 and the variance of signals is recalculated based on the signals corresponding to the remaining candidate peaks on the list at block 965. For example, during the first iteration, k=1, and thus a first candidate peak if removed from the list and the variance of signals is recalculated without the signal corresponding to the first candidate peak.

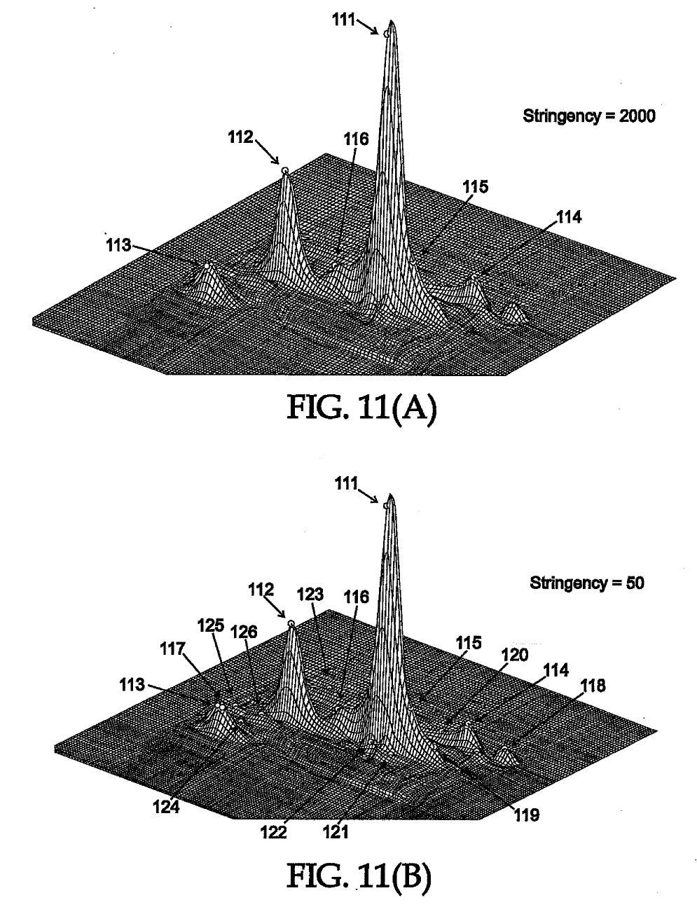

At block 966, the recalculated variance is compared with the aggregate variance previously calculated at block 963, and the difference between the recalculated and aggregate variances is compared with the stringency value at block 967. When the difference between the recalculated and aggregate variances is greater than the stringency value (block 967: Yes), the candidate peak k is labeled a true peak and removed permanently from list at block 968. The true peak k may also be added to a list of true peaks, which may be stored, for example, in results database 348 at block 969, for later reference. When the difference between the recalculated and aggregate variances is not greater than stringency value (block 967: No), the candidate peak k is placed at the end of the list at block 970. Notably, in this process, the larger the value of stringency, the fewer candidate peaks will be identified as true peaks, as shown for example in FIGS. 11A and 11B, discussed below.

At block 971, it is determined whether there are any candidate peaks remaining on the list. For example, the total number of candidate peaks may be represented by n, in which case a determination in made at block 971 of whether k=n. When there are no remaining candidate peaks (e.g., k=n), the peak selection process ends, and the list of true peaks is complete. When there are remaining candidate peaks (e.g., k<n), then the variable k is incremented by one at block 972, and blocks 963 through 971 are repeated. In an alternative embodiment, the peak selection process simply continues without determining whether any candidate peaks are remaining, as long as there are candidate peaks on the list.

Referring again to FIG. 9, in a second iteration, for example, k has been incremented to 2 at block 972 and the process returns to block 963. A second aggregate variance of the signals corresponding to all candidate peaks remaining in the list is calculated at block 963. When the first candidate peak has been returned to the end of the list (e.g., at block 970), the second aggregate variance calculated in the second iteration will be the same as that calculated in the first iteration. Conversely, when the first candidate peak has been identified as a true peak and permanently removed from the list (e.g., at block 968), the second aggregate variance calculated in the second iteration will be smaller than that calculated in the first iteration.

The second candidate peak is removed from the list at block 964 and the variance of the remaining signals is recalculated at blocks 965. At block 966, the recalculated variance is compared with the second aggregate variance, and the difference between the recalculated and second aggregate variances is compared with the stringency value at block 967. When the difference between the recalculated and second aggregate variances is greater than the stringency value (968: Yes), the second candidate peak is labeled a true peak and removed permanently from list at block 968. The second candidate peak may also be added to the list of true peaks and stored at block 969. When the difference between the recalculated and aggregate variances is not greater than the stringency value (967: No), the second candidate peak is placed at the end of the list at block 970.

The process is repeated through subsequent iterations until k is equal to the total number of candidate peaks, and/or a full examination of all candidate peaks from the list does lead to new true peaks. For example, in an alternative embodiment, the process of FIG. 9 repeats until there are N candidate peaks left after identifying all of the true peaks, according to a given stringency value. The process then repeats N more times without leading to any new true peaks, e.g., in the decision of block 967, at which point the process ends.

An example of true peaks which have been identified by the true peak selection of FIG. 9 is shown in FIG. 10, which is a graph showing the three-dimensional data set of the two-dimensional smooth signal Sₛₘₒₒₜₕ(x, y) shown in FIG. 8. In the depicted example, five true peaks 101-105 have been detected, indicated by corresponding circles. The overall peak detection process of FIG. 4 is thus able to detect highly overlapped peaks.

In an alternative embodiment, each candidate peak may be identified as a true peak or ancillary peak at substantially the same time it is identified as a candidate peak (e.g., at block 755 of FIG. 7). That is, the candidate peaks are compared with a predetermined threshold, which may be based on the stringency value. When the candidate peak exceeds the predetermined threshold, it is identified as a true peak, and when the he candidate peak does not exceed the predetermined threshold, it is identified as an ancillary peak.

As noted above, the description of FIG. 9 assumes that the background or baseline of the signal does not change substantially along the region of interest being analyzed. When the baseline can not be approximated by a constant value, the iterative selection procedure of FIG. 9 used for peak selection could fail. Should this situation arise, baseline subtraction may be performed, as described for example at block 440 of FIG. 4, using any appropriate method of baseline subtraction, as would be apparent.

It is further assumed that the area of the chromatogram covered with peaks does not represent the majority of the support of the smooth signal Sₛₘₒₒₜₕ(x, y). This is because there must be enough candidate peaks that do not become true peaks (i.e., the ancillary peaks) for the peak selection process of FIG. 9 to work properly, since the ancillary peaks are used, in part, to provide the aggregate variance of signal. The majority of the ancillary peaks originate from small fluctuations in the baseline.

Peak positions determined via local maxima of H are sometimes very close to, but not right at a true peak, which coincides with the maximum signal intensity for the case of isolated peaks. Therefore, the peak detection process is intended for subsequent quantitative analysis, where for instance, overlapped peaks are deconvolved by an optimization procedure. As a result of the optimization procedure, precise positions of the peaks are provided. However, in order for the optimization procedure to work, appropriate initial conditions, such as the number of peaks and their approximate parameters, are required, as provided by the peak detection process.

FIGS. 11A and 11B are graphs showing other examples of peak detection from an experimental set, which constitutes a portion of a urine sample separated by two-dimensional liquid chromatography. FIGS. 11A and 11B differ from one another in the stringency value, which determines the number of solutions.

In particular, FIG. 11A is a graph 1101 of a three-dimensional data set of a two-dimensional signal showing detected true peaks 111-116 using a stringency value of 2000, and FIG. 11B is a graph 1102 of the three-dimensional data set showing detected true peaks 111-126 using a lower stringency value of 50. The lower stringency value 50 yielded ten true peaks 117-126, in addition to the five true peaks 111-116 yielded using the stringency value 2000. In an embodiment, graphs 1101 and/or 1102 are displayed (e.g., on display 1234 of FIG. 12, discussed below), including displayed markers respectively indicating the true peaks, depending on the stringency value.

FIG. 12 is a functional block diagram illustrating a system 1200, according to a representative embodiment. The system 1200 may be any system for receiving and processing two-dimensional signals, such as signals produced in accordance with chromatography, mass spectrometry, spectroscopy, electrophoresis, imaging, electronic measurements and the like. The system 1200 may represent an LC/MS system, which generally combines separation functionality of liquid chromatography with mass analysis ability of mass spectrometry, and which collects, measures, processes and/or analyzes various samples for identification and generates two-dimensional representations based on three-dimensional data sets.

In the depicted representative embodiment, the system 1200 includes a two-dimensional separator 1210 and a peak detector 1230. The two-dimensional separator 1210 receives samples, which may include various mixtures of molecules (e.g., peptides, proteins, or the like) to be identified. As stated above, the samples may be separated by the two-dimensional separator via various types of separation processing to reduce the complexity of the mixture and to isolate to the extent possible individual compounds contained within sample. Isolation may occur spatially or temporally, for example. The two-dimensional separator 1210 may perform separation processing in accordance with any appropriate separation system, including two-dimensional gel electrophoresis and LC/MS, and may be implemented in part using a microfluidic device, for example. One example of performing two-dimensional separations of tryptic digests using glass microfluidic devices is described by Ramsey et al., High-Efficiency, Two-Dimensional Separations of Protein Digests on Microfluidic Devices, ANAL. CHEM., Vol. 75, No. 15 (Aug. 1, 2003), pp. 3758-3764, the contents of which is hereby incorporated by reference.

The peak detector 1230 performs processing on the sample separations, including detecting peaks, in according with various embodiments discussed below. The peak detector 1230 may be a computer processor, for example, and includes central processing unit (CPU) 1231, internal memory 1232, bus 1239 and interfaces 1235-1238, and is configured to interface with the two-dimensional sample separator 1210 through a respective interface 1212, which may be a universal serial bus (USB) interface, an IEEE 1394 interface, or a parallel port interface, for example. As stated above, it is understood that, although depicted separately, the peak detector 1230 may be included within the two-dimensional separator 1210, in various embodiments.

With respect to the peak detector 1230, the internal memory 1232 includes at least nonvolatile read only memory (ROM) 1233 and volatile random access memory (RAM) 1234, although it is understood that internal memory 1232 may be implemented as any number, type and combination of ROM and RAM, and may provide look-up tables and/or other relational functionality. In various embodiments, the internal memory 1232 may include a disk drive or flash memory, for example. Further, the internal memory 1232 may store program instructions and results of calculations or summaries performed by CPU 1231.

The CPU 1231 is configured to execute one or more software algorithms, including the peak detection process of the embodiments described herein, in conjunction with the internal memory 1232. In various embodiments, the CPU 1231 may also execute software algorithms to control the basic functionality of the system 1200. The CPU 1231 may include its own memory (e.g., nonvolatile memory) for storing executable software code that allows it to perform the various functions. Alternatively, the executable code may be stored in designated memory locations within internal memory 1232. The CPU 1231 executes an operating system, such as a Windows® operating system available from Microsoft Corporation, a Linux operating system, a Unix operating system (e.g., Solaris™ available from Sun Microsystems, Inc.), or a NetWare® operating system available from Novell, Inc. The operating system may control execution of other programs, including collection and separation of samples and output of corresponding signals by the two-dimensional separator 1210.

In an embodiment, a user and/or other computers may interact with the peak detector 1230 using input device(s) 1245 through I/O interface 1235. The input device(s) 1245 may include any type of input device, for example, a keyboard, a track ball, a mouse, a touch pad or touch-sensitive display, and the like. Also, information may be displayed by the peak detector 1230 on display 1246 through display interface 1236, which may include any type of graphical user interface (GUI), for example. The displayed information includes the processing results obtained by the CPU 1231 executing the method of peak detection, described herein.

The processing results of the CPU 1231 may also be stored in the results database 1248 through memory interface 1238. The database 1248 may include any type and combination of volatile and/or nonvolatile storage medium and corresponding interface, including hard disk, compact disc (e.g., CD-R/CD/RW), universal serial bus (USB), flash memory, or the like. The stored processing results may be viewed, e.g., on the display 1246, and/or further processed at a later time. Also, the processing results may be provided to other computer systems connected to network 1247 through network interface 1237. The network 1247 may be any network capable of transporting electronic data, such as the Internet, a local area network (LAN), a wireless LAN, and the like. The network interface 1237 may include, for example, a transceiver (not shown), including a receiver and a transmitter, that provides functionality for the system 1200 to communicate wirelessly over the data network through an antenna system (not shown), according to appropriate standard protocols. However, it is understood that the network interface 1237 may include any type of interface (wired or wireless) with the communications network, including various types of digital modems, for example.

The various “parts” shown in FIG. 12 of the peak detector 1230 may be physically implemented using a software-controlled microprocessor, hard-wired logic circuits, or a combination thereof. Also, while the parts are functionally segregated for explanation purposes, they may be combined variously in any physical implementation.

While specific embodiments are disclosed herein, many variations are possible, which remain within the scope of the invention. Such variations would become apparent after inspection of the specification, drawings and claims herein. The invention therefore is not to be restricted except within the scope of the appended claims.

What is claimed is:

1. A system for detecting true peaks in a two-dimensional signal, the system comprising:
a two-dimensional separator configured to perform separation of a sample to provide the two-dimensional signal comprising a plurality of points, the two-dimensional signal defining a surface; and
a processor configured to perform operations comprising identifying candidate peaks of the two-dimensional signal based on local maxima of points on a surface derived from the two-dimensional signal, and identifying at least one true peak from the candidate peaks.

2. The system of claim 1, wherein identifying the candidate peaks comprises:
determining a derived surface as a mean curvature of the surface at each point of the two dimensional signal; and
determining local maxima of the mean curvature.

3. The system of claim 2, wherein determining the mean curvature at each point comprises:
calculating a normalized vector for each point on the surface of the two-dimensional signal;
determining a plurality of principal curvatures for each point using the corresponding normalized vector; and
averaging the plurality of principal curvatures for each point.

4. The system of claim 2, wherein identifying the at least one true peak from the candidate peaks comprises:
comparing the value of the signal associated with each candidate peak to a predetermined threshold; and
identifying each candidate peak that exceeds the predetermined threshold as the at least one true peak.

5. The system of claim 1, wherein identifying the at least one true peak from the candidate peaks comprises:
calculating a first aggregate variance of values of the two-dimensional signal at locations corresponding to the candidate peaks;
removing a first candidate peak and recalculating a variance of values of the two-dimensional signal at locations corresponding to remaining candidate peaks;
comparing the recalculated variance with the first aggregate variance to determine a variance difference; and
identifying the first candidate peak as a true peak when the variance difference exceeds a predetermined stringency value.

6. The system of claim 5, wherein the first candidate peak is removed from the candidate peaks when the first candidate peak is identified as a validated peak.

7. The system of claim 5, wherein the first candidate peak is identified as an ancillary peak when the variance difference does not exceed the predetermined stringency value.

8. The system of claim 6, wherein the processor is further configured to perform operations comprising:
calculating a second aggregate variance of values of the two-dimensional signal at locations corresponding to the remaining candidate peaks;
removing a second candidate peak and recalculates a variance of values of the two-dimensional signal at locations corresponding to second remaining candidate peaks;
comparing the recalculated variance with the second aggregate variance to determine a second variance difference;
determining whether the second variance difference exceeds the predetermined stringency value; and
identifying the second candidate peak as another true peak when second variance difference exceeds the predetermined stringency value.

9. The system of claim 1, wherein the stringency value is inversely proportional to the number of true peaks identified from the candidate peaks.

10. The system of claim 1, wherein the processor is further configured to perform operations comprising causing noise reduction to be performed on the two-dimensional signal prior to identifying the candidate peaks.

11. The system of claim 10, wherein the processor is further configured to perform operations comprising interpolating the two-dimensional signal along at least one of the two dimensions prior to identifying the candidate peaks.

12. In a system for detecting true peaks in a two-dimensional signal, the system comprising a two-dimensional separator configured to perform separation of a sample to provide the two-dimensional signal comprising a plurality of points, the two-dimensional signal defining a surface, and a processor, a method of detecting validated peaks in a two-dimensional signal from the two-dimensional separator based on the separation of the sample, the method comprising:
identifying candidate peaks of the two-dimensional signal, the two-dimensional signal defining a surface, the candidate peaks corresponding to local maxima on the surface, each local maximum being based on a mean curvature at a point on the surface defined by the two-dimensional signal;
identifying at least one true peak from the candidate peaks based on a peak threshold value; and
displaying the surface defined by the two-dimensional signal and at least one marker corresponding to the at least one true peak.

13. The method of claim 12, wherein identifying the candidate peaks comprises:
calculating a vector for each point on the surface defined by the two-dimensional signal;
determining the mean curvature at each point using the corresponding vector; and
determining the local maxima of the points based on the mean curvature at each point.

14. The method of claim 13, wherein determining the mean curvature at each point comprises:
determining a plurality of principal curvatures for each point using the corresponding vector; and
averaging the plurality of principal curvatures for each point.

15. The method of claim 13, wherein identifying at least one true peak from the candidate peaks comprises:
comparing each candidate peak to a predetermined threshold; and
identifying each candidate peak that exceeds the predetermined threshold as the at least one true peak.

16. The method of claim 12, wherein identifying at least one true peak from the candidate peaks comprises:
calculating a first aggregate variance of values of the two-dimensional signal at locations corresponding to the candidate peaks;
removing a first candidate peak from the candidate peaks and calculating a second variance of values of the two-dimensional signal at locations corresponding to the remaining candidate peaks;
comparing the second variance with the aggregate variance to determine a variance difference;
determining whether the variance difference exceeds a predetermined stringency value; and
when variance difference exceeds the predetermined stringency value, identifying the first candidate peak as a true peak.

17. A computer readable medium storing a program, executable by a computer processor, for detecting true peaks in a two-dimensional signal, the two-dimensional surface defining a surface, the computer processor operating in response to the program to perform operations comprising:
identifying candidate peaks of the two-dimensional signal based on local maxima of points on the surface; and
identifying at least one true peak from the candidate peaks.

18. The computer readable medium of claim 17, wherein identifying candidate peaks comprises:
calculating a normalized vector for each point on the surface defined by the two-dimensional signal;
determining a mean curvature at each point using the corresponding normalized vector; and
determining the local maxima of the points based on the mean curvature at each point, the local maxima comprising the candidate peaks.

19. The computer readable medium of claim 18, wherein determining the mean curvature at each point comprises:
determining a plurality of principal curvatures for each point using the corresponding normalized vector; and
averaging the plurality of principal curvatures for each point.

20. The computer readable medium of claim 17, wherein identifying the at least one true peak comprises:
comparing each candidate peak to a predetermined threshold; and
identifying each candidate peak that exceeds the predetermined threshold as the at least one true peak.
